(19) United States
(12) Patent Application Publication
(10) Pub. No.: US 2015/0219872 A1
(43) Pub. Date: Aug. 6, 2015

(54) LENS DRIVING DEVICE

(71) Applicants: Huizhou Dayawan Ever Bright Electronic Industry Co., Ltd., Huizhou (CN); JSS Optical Technology Co., Ltd., HONG KONG (HK); Huizhou Daya Bay Jss Optical Technology.Co., Ltd., Huizhou (CN)

(72) Inventor: Kokichi Terajima, Tokyo (JP)

(21) Appl. No.: 14/607,097

(22) Filed: Jan. 28, 2015

(30) Foreign Application Priority Data
Jan. 31, 2014 (JP) 2014-017543

(51) Int. Cl. G02B 7/04; G03B 3/10; G02B 7/02

(52) U.S. Cl. CPC G02B 7/04; G02B 7/026; G03B 3/10

(57) ABSTRACT

The present invention aims to provide a lens driving device incapable of inclining even when a lens support moves. An outer side retaining part of a back side spring component is connected with the back side of a box body in a manner that the outer side retaining part and an inner side retaining part of the back side spring component connected to the lens support are formed on the same plane. An outer side retaining part of a front side spring component is connected with the front side of the box body in a manner that the outer side retaining part is positioned closer to the back of the optical axis than the inner side retaining part of the front side spring component, so that the lens support is subjected to a force towards the back of the optical axis.

### BACKGROUND OF THE INVENTION

1. Field of the Invention

The present invention relates to a lens driving device enabling a lens support supported by spring components in a suspension manner to move towards the direction of an optical axis by utilizing an electromagnetic driving mechanism.

2. Description of Related Art

FIG. 7A is an exploded view of a lens driving device 20 provided with an existing electromagnetic driving mechanism, and FIG. 7B is a top view of a spring component 24 used in the lens driving device 20.

The lens driving device 20 is provided with a cylindrical front side box body 21, a back side box body 22 connected to the front side box body 21, a lens support 23 disposed on the inner circumference side of the front side box body 21, and two spring components 24. The two spring components 24 are a front side spring component 24A and a back side spring component 24B which are formed in the same shape and are respectively mounted on an upper side and a lower side of the lens support 23. When the optical axis of the not shown lens is taken as Z axis, the front side spring component 24 is disposed on the front side (+Z side) of the optical axis (Z axis) of the lens support 23. Relatively, the back side spring component 24B is disposed on the back side (−Z side) of the optical axis (Z axis) of the lens support 23.

The front side box body 21 is a soft magnetic body, and plays functions and effects as a magnetic yoke. The front side box body 21 is provided with an approximately U-shaped cross section, and is composed of an outer circumference part 21a, an inner circumference part 21b and a top surface part 21c for connecting the outer circumference part 21a and the inner circumference part 21b at the +Z side. A column-shaped magnet assembly 25 composed of four circular arc permanent magnets and disposed to be cylindrical is mounted on the inner wall of the outer circumference part 21a of the front side box body 21. A coil 26 is disposed between the magnet assembly 25 and the inner circumference part 21b of the front side box body 21. The coil 26 and the inner circumference part 21b, and the coil 26 and the magnet assembly 25 are all disposed opposite to one another and partitioned at intervals. The coil 26 is fixed on the +Z side of the outer circumference part 23a of the lens support 23. The outer circumference part 23a of the lens support 23 enters the −Z side of the inner circumference part 21b of the front side box body 21, and the coil 26 can move along the Z direction in the space formed by the inner circumference part 21b of the front side box body 21, the magnet assembly 25, and the top surface part 21c.

The back side box body 22 is provided with an outer circumference wall 22a arranged along the outer circumference part 21a of the front side box body 21 and a base part 22b positioned on the back side (−Z side) of the lens support 23. The front side box body 21 is fixed on the inner circumference side of the outer circumference wall 22a of the back side box body 22. Moreover, an outer side retaining part 24b of the back side spring component 24B is fixed on the base part 22b.

The lens support 23 is formed to be in the shape of a cylinder capable of housing the lens not shown at the interior. The lens support 23 is such mounted that the lens support 23 can move along the optical axis (Z axis) on the inner circumference side of the front side box body 21.

As shown in FIG. 7B, the spring component 24 is a plate spring integrally formed to be annular. The spring component 24 is provided with a circular ring-shaped inner side retaining part 24a mounted on the side of the lens support 23, an outer side retaining part 24b mounted on the side of the back side box body 22, a plurality of wrist parts 24c disposed between the inner side retaining part 24a and the outer side retaining part 24b and extending along the circumference direction, inner side connecting parts 24m each for connecting the inner side retaining part 24a with one end of a corresponding one wrist part 24c, and outer side connecting parts 24n each for connecting the outer side retaining part 24b with the other end of the corresponding wrist part 24c.

The inner side retaining part 24a of the front side spring component 24A is fixed on the +Z side surface of the connecting end 23c on the +Z side of the lens support 23, and the outer side retaining part 24b of the front side spring component 24A is fixed on the +Z side surface of the top surface part 21c of the front side box body 21.

The inner side retaining part 24a of the back side spring component 24B is fixed on the −Z side surface of the outer circumference part 23a of the lens support 23, and the outer side retaining part 24b of the back side spring component 24B is fixed on the +Z side surface of the base part 22b of the back side box body 22.

The front side spring component 24A and the back side spring component 24B for forming the spring components 24 are both formed to be in flat shapes extending in the X direction and Y direction under the natural state (unloaded state) before being assembled. Relatively, as shown in FIG. 8D, after the spring components 24 are assembled, the outer side retaining part 24b is positioned closer (more offset) to the −Z side than the inner side retaining part 24a to form a state that the wrist parts 24c are bent.

Along with the assembling of the spring components 24, the lens support 23 is subjected to acting force towards −Z axis generated by restoring force of the wrist parts 24c. When the coil 26 is not electrified, the back end part 23d of the lens support 23 abuts against the base part 22b of the back side box body 22, and the optical axis of the lens faces the direction of the Z axis. Moreover, along with the electrification of the coil 26, +Z axis direction driving force exceeding −Z axis direction spring force generated by the spring components 24 is generated, and thus the back end part 23d of the lens support 23 leaves away from the base part 22b and floats up in the direction of +Z axis.

The above described lens driving device is disclosed at least by two JP patents whose patent No. are 2004-280031 and 2005-128392.

FIG. 8A to FIG. 8D are mode patterns illustrating the assembling working procedure of the lens driving device 20.

As shown in FIG. 8A, the inner side retaining part 24a of the back side spring component 24B is fixed on the +Z side surface of the outer circumference part 23a of the lens support 23. As shown in FIG. 8B, after respective centers of the lens support 23 and the back side box body 22 are positioned coincidently, the back end part 23d of the lens support 23 connected with the inner side retaining part 24a of the back side spring component 24B abuts against the front side of the base part 22b of the back side box body 22. The outer side retaining part 24b of the back side spring component 24B is pushed at a distance closer to the −Z side than the inner side retaining part 24a, and in the offset state, the outer side retaining part 24b of the back side spring component 24B is pressed and fixed on the +Z side surface of the base part 22b.

The outer side retaining part 24b of the back side spring component 24B is offset to the −Z side, and the inner side retaining part 24a is subjected to the −Z axis direction acting force generated by restoring force of the wrist parts 24c. Due to the fact that the inner side retaining part 24a of the back side spring component 24B is subjected to force away from the −Z side surface of the outer circumference 23a of the lens support 23 through pulling, the inner side retaining part 24a needs to be fixed on the −Z side surface of the outer circumference 23a of the lens support 23 before the outer side retaining part 24b is fixed on the base part 22b of the back side box body 22.

As shown in FIG. 8C and FIG. 8D, a magnet assembly 25 is mounted on the inner wall of the outer circumference part 21a of the front side box body 21, and the front side box body 21 is fixed on the +Z side of the base part 22b in a surrounding manner. The inner side retaining part 24a of the front side spring component 24A is fixed on the +Z side surface of the connecting end 23c on the +Z side of the lens support 23, and the outer side retaining part 24b of the front side spring component 24A is pressed and fixed to the +Z side surface of the top surface part 21c in a state that the outer side retaining part 24b is offset at a distance D closer to the −Z side than the inner side retaining part 24a.

As shown in FIG. 9, along with the electrification of the coil 26 of the lens driving device 20, when the lens support 23 leaves away from the back side box body 22 and begins to float up, the lens support 23 generates inclination to cause tilt. As a reason for causing the tilt, the most possibility is that the wrist parts 24c of the back side spring component 24B generate residual stress along the direction forming the right angle with the Z axis.

Namely, in the section view mode pattern as shown in FIG. 7C, the back side spring component 24B is in the state that the inner side retaining part 24a is fixed on the −Z side surface of the outer circumference part 23a of the lens support 23 and the outer side retaining part 24b is not fixed. Therefore, the outer side retaining part 24b hangs down and inclines due to self weight, and the center Ob of the outer side retaining part 24b is offset at a distance S from the center Of of the inner side retaining part 24a to the direction forming the right angle with the Z axis so as to be decentering and eccentric. Moreover, due to the fact that the back side spring component 24B is eccentrically pressed and fixed to the base part 22b of the back side box body 22, the outer side retaining part 24b still keeps in an eccentric state. When the outer side retaining part 24b is in the eccentric state, the wrist parts 24c of the back side spring component 24B for connecting the inner side retaining part 24a with the outer side retaining part 24b generate stress in the direction perpendicular to the Z axis, and the stress remains.

The lens support 23 after the assembling working procedure as shown in FIG. 8C and FIG. 8D is subjected to the acting force in the direction of −Z axis, the back end part 23d is pressed on the base part 22b of the back side box body 22, and thus the wrist parts 24c formed on the back side spring component 24B is always in the state that the stress in the direction forming the right angle with the Z axis remains. Moreover, when the coil is electrified so that the lens support 23 floats up, the stress remaining on the wrist parts 24c of the back side spring component 24B is released, the inner side retaining part 24a moves towards the center of the outer side retaining part 24b fixed in the eccentric state so as to reduce the eccentricity, and the lens support 23 can rotate around the axis forming the right angle with the Z axis, thus cause tilt.

Thus, a tilt is generated on the lens retained on the lens support 23 due to the tilt of the lens support 23, and thus the problems of image degradation such as focused image distort, color doping or dim and image strain may be caused.

### BRIEF SUMMARY OF THE INVENTION

The present invention is provided in view of existing problems, and aims to provide a lens driving device incapable of inclining when a lens support moves.

The lens driving device of the present invention is provided with a lens support, a box body, plate-like spring components and an electromagnetic driving mechanism, wherein the lens support is used for retaining a lens on the inner side by taking the side of a object to be shot as the front side of the direction of an optical axis; the box body is arranged on the outer side of the lens support; the plate-like spring components are used for connecting the lens support with the box body and supporting the lens support in a suspension manner to move in the direction of the optical axis of the lens; the electromagnetic driving mechanism is used for driving the lens support in the direction of the optical axis. The lens driving device is characterized in that the spring components include a front side spring component for supporting the front side (part) of the lens support in the direction of the optical axis and a back side spring component for supporting the back side of the lens support in the direction of the optical axis; each of the front side spring component and the back side spring component is respectively provided with a wrist part, an inner side retaining part and an outer side retaining part, wherein the inner side retaining part is arranged on the inner side of the wrist pat and is connected with the lens support; the outer side retaining part is arranged on the outer side of the lens support and is connected with the box body; one end of the wrist part is connected with the inner side retaining part, and the other end of the wrist part is connected with the outer side retaining part, the outer side retaining part of the back side spring component is connected with the box body in a manner that the outer side retaining part of the back side spring component and the inner side retaining part connected to the lens support are formed on the same plane, the outer side retaining part of the front side spring component is connected with the box body in a manner that the outer side retaining part of the front side spring component is positioned closer to the back of the direction of the optical axis than the inner side retaining part of the lens support, and the lens support is subjected to acting force in the back of the direction of the optical axis.

Thus, the outer side retaining part of the back side spring component is connected with the box body in a manner that the outer side retaining part of the back side spring component and the inner side retaining part connected to the lens support are formed on the same plane, so that the outer side retaining part of the front side spring component is closer to the back of the direction of the optical axis than the inner side retaining part connected to the lens support so as to be connected with the box body, only the front side spring component applies force to the back of the lens support in the direction of the optical axis, and thus eccentricity cannot occur under the condition that the outer side retaining part of the back side spring component is connected with the box body, and the stress in the direction forming the right angle with the Z axis does not remains in the wrist part. Thus, when the coils are electrified and the lens support floats up, the lens support can be inhibited from rotating around the axis forming a right angle relative to the optical axis, and thus the lens support is difficult to decline.

Moreover, the lens driving device of the present invention is provided with the lens support, the box body, the plate-like spring components and the electromagnetic driving mechanism, wherein the lens support is used for retaining the lens on the inner side by taking the side of the object to be shot as the front side of the optical axis; the box body is arranged on the outer side of the lens support; the plate-like spring components are used for connecting the lens support with the box body and supporting the lens support in a suspension manner to move in the direction of the optical axis of the lens; the electromagnetic driving mechanism is used for driving the lens support in the direction of the optical axis. The lens driving device is characterized in that the spring components include the front side spring component for supporting the front side (part) of the lens support in the direction of the optical axis and the back side spring component for supporting the back side of the lens support in the direction of the optical axis; each of the front side spring component and the back side spring component is respectively provided with a plurality of wrist parts, inner side retaining parts and outer side retaining parts, wherein the inner side retaining parts are arranged on the inner sides of the wrist pats and are connected with the lens support; the outer side retaining parts are arranged on the outer sides of the lens supports and are connected with the box body; one end of each of the wrist parts is connected with the inner side retaining parts, and the other ends of the wrist parts are connected with the outer side retaining parts, the outer side retaining part of the back side spring component is connected with the box body in a manner that the outer side retaining part of the back side spring component and the inner side retaining part connected to the lens support are formed on the same plane, the outer side retaining part of the front side spring component is arranged on the wrist parts and are connected with the box body in a state of being not parallel to the plane forming the right angle with the optical axis, and thus the lens support is subjected to the acting force in the back of the direction of the optical axis. In this way, the outer side retaining part of the back side spring component is connected with the box body in a manner that the outer side retaining part of the back side spring component and the inner side retaining part connected to the lens support are formed on the same plane; the outer side retaining part of the front side spring component is divided into a plurality of parts in each wrist part and is connected with the box body by forming an angle that the outer side retaining part is not parallel to the plane forming the right angle with the Z axis, and only the front side spring component applies force to the lens support towards the back of the direction of the optical axis, and thus eccentricity does not occur under the condition that the outer side retaining part of the back side spring component is connected with the box body, and the stress in the direction forming the right angle with the Z axis cannot remain in the wrist parts. Thus, when the coils are electrified and the lens support floats up, the lens support can be inhibited from rotating around an axis forming a right angle relative to the optical axis, and thus the lens support is difficult to decline.

Moreover, the summary of the invention does not list all features required by the present invention, and auxiliary combination of these features can also become the present invention.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1A is an exploded view of a lens driving device according to a first embodiment of the present invention.

FIG. 1B is a top view of a spring component according to the first embodiment of the present invention.

FIGS. 2A to 2D are cross-sectional views illustrating an assembling working procedure of the lens driving device in the first embodiment of the present invention.

FIG. 3 is an exploded view illustrating another lens driving device of the first embodiment of the present invention.

FIG. 4A is an exploded view of a lens driving device according to a second embodiment of the present invention.

FIG. 4B is a top view of a spring component according to the second embodiment of the present invention.

FIGS. 5A to 5D are cross-sectional views illustrating a assembling working procedure of the lens driving device in the second embodiment of the present invention.

FIG. 6 is an exploded view illustrating another lens driving device in the second embodiment of the present invention.

FIG. 7A is an exploded view of an existing lens driving device.

FIGS. 7B and 7C are respectively a top view and a cross-sectional view of an existing spring component used in the existing lens driving device of FIG. 7A, the existing spring component in FIG. 7C has been assembled in the lens driving device.

FIGS. 8A to 8D are cross-sectional views illustrating the assembling working procedure of the existing lens driving device.

FIG. 9 is a cross-sectional view illustrating a state of the existing lens driving device when the coil is electrified.

### DETAILED DESCRIPTION OF THE INVENTION

The invention will now be described in detail through several embodiments with reference to the accompanying drawings. The following embodiments do not limit scope of the claims of the present invention, and the combination of all features described in the embodiments does not necessary for solutions of the present invention.

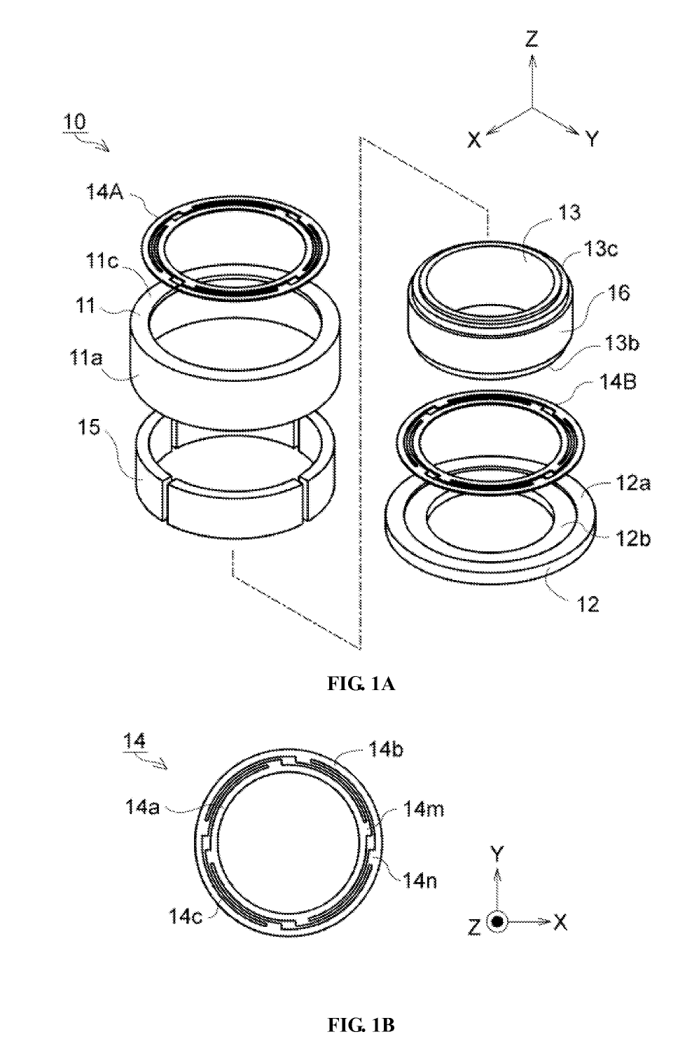

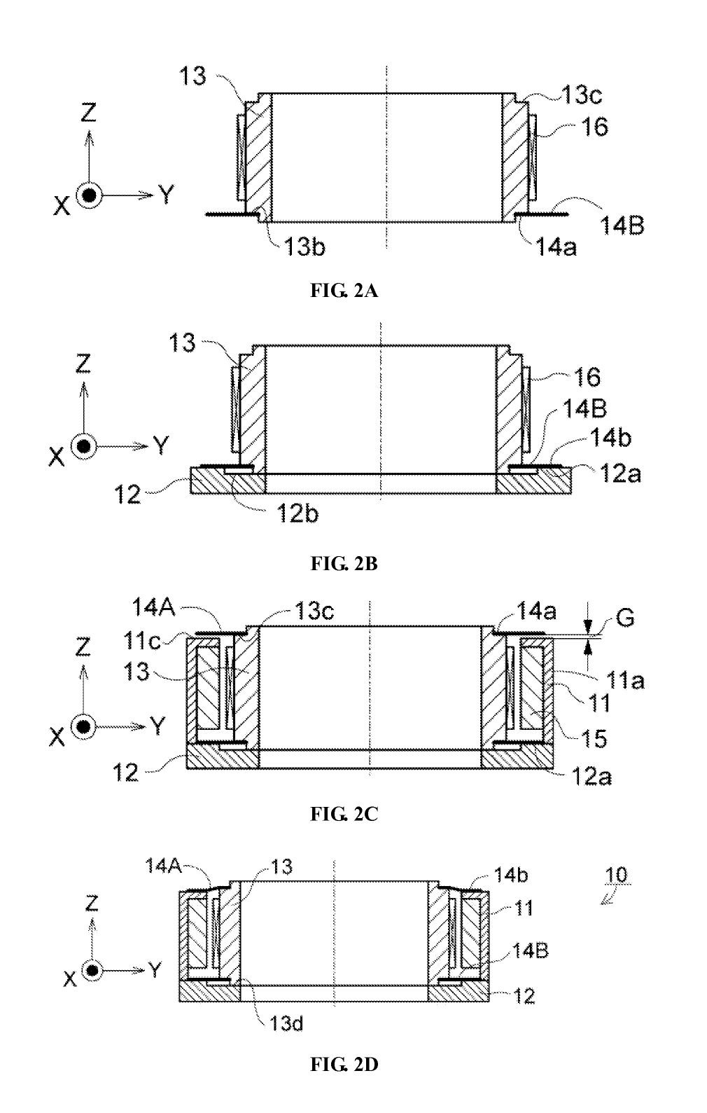

FIG. 1A is an exploded view of a lens driving device 10 according to a first embodiment, and FIG. 1B is a top view illustrating a spring component 14 used in the lens driving device 10. Moreover, FIG. 2 A to FIG. 2D are four cross-sectional views illustrating the assembling working procedure of the lens driving device 10 in the first embodiment of the present invention.

The lens driving device 10 is provided with a cylindrical front side box body 11, a back side box body 12 connected with the front side box body 11, a lens support 13 assembled on the inner circumference side of the front side box body 11 and used for retaining a lens, and two spring components 14 composed of a front side spring component 14A and a back side spring component 14B which are all mounted on the lens support 13. In the description of the embodiment, the direction of the optical axis of the not shown lens is taken as the direction of Z (Z axis), and the side of the object to be shot is taken as the front side (+Z side) of the optical axis (Z axis). The front side spring component 14A is disposed on the front side (+Z side) of the optical axis of the lens support 13, and the back side spring component 14B is disposed on the back side (−Z side) of the optical axis of the lens support 13.

The front side box body 11 is formed by a soft magnetic body and is arranged on the outer circumference side of the lens support 13 so as to serve as a magnetic yoke to play functions and effects. The front side box body 11 is provided with an approximately L-shaped cross section, and includes an outer circumference part 11a and a top surface part 11c bent from the +Z side of the outer circumference part 11a to the direction of the inner diameter. A magnet assembly 15 is composed of several circular arc permanent magnets and is formed to be column-shaped, and the several circular arc permanent magnets are attached to the inner wall of the outer circumference part 11a of the front side box body 11 so as to be formed in a cylindrical shape. A cylindrical coil 16 is disposed within the inner circumference side of the magnet assembly 15, and a gap is existed between the magnet assembly 15 and the coil 16 along the radial direction. The coil 16 is attached on the outer circumference side surface of the lens support 13. Moreover, the coils 16 and the magnet assembly 15 together form an electromagnetic driving mechanism for driving the lens support 13 in the direction of the optical axis. The lens support 13 can move along the Z direction in the space defined by the inner circumference side of the magnet assembly 15.

The back side box body 12 is arranged on the back side of the optical axis of the lens support 13. A circular opening is formed in the central part of the back side box body 12, and the back side box body 12 includes an outer circumference wall 12a arranged along the outer circumference part 11a of the front side box body 11 and a base part 12b positioned on the back side (−Z side) of the lens support 13. The front side box body 11 is fixed at the front end part of the outer circumference wall 12a of the back side box body 12. Moreover, an outer side retaining part 14b of the back side spring component 14B is fixed on the outer circumference wall 12a.

The lens support 13 is formed to be in the shape of a cylinder capable of housing the not shown lens at the interior. The lens support 13 is mounted on the inner circumference side of the front side box body 11, and can move along the direction of the optical axis (Z axis).

As shown in FIG. 1B, each spring component 14 is integrally formed to be an annular plate spring, and is used for supporting the lens support 13 to move in the direction of the optical axis of the lens in a suspension manner. Each spring component 14 is provided with a circular ring-shaped inner side retaining part 14a mounted on the side of the lens support 13, an outer side retaining part 14b mounted on the side of the front and back side box bodies 11, 12, a plurality of wrist parts 14c disposed between the inner side retaining part 14a and the outer side retaining part 14b and extending along the circumference direction, a plurality of inner side connecting parts 14m connecting the inner side retaining part 14 with one ends of the wrist parts 14c, and a plurality of outer side connecting parts 14n connecting the outer side retaining part 24b with the other ends of the wrist parts 24c.

The inner side retaining part 14a of the front side spring component 14A is fixed on the +Z side surface of the connecting end 13c on the +Z side of the lens support 13, and the outer side retaining part 14b of the front side spring component 14A is fixed on the +Z side surface of the top surface part 11c of the front side box body 11. Moreover, the inner side retaining part 14a of the back side spring component 14B is fixed on the −Z side surface of the connecting end 13b on the −Z side of the lens support 13, and the outer side retaining part 14b of the back side spring component 14B is fixed on the +Z side surface of the outer circumference wall 12a of the back side box body 12.

Below, referring to FIG. 2A to FIG. 2D, the basic assembling steps of the lens driving device 10 are described.

As shown in FIG. 2A, the inner side retaining part 14a of the back side spring component 14B is fixed on the −Z side connecting end 13b of the lens support 13 mounted the coil 16. Then, as shown in FIG. 2B, after the center of the lens support 13 and the center of the back side box body 12 are aligned at the same position, the lens support 13 connected to the inner side retaining part 14a of the back side spring component 14B abuts against the front side of the base body 12b. Moreover, in a manner that the heights of the outer side retaining part 14b and the inner side retaining part 14a in the Z direction are the same, the outer side retaining part 14b is pressed and fixed to the +Z side surface of the outer circumference wall 12a of the back side box body 12.

In such state, the inner side retaining part 14a, the outer side retaining part 14b, and the wrist parts 14c of the back side spring component 14B are formed on the same plane, and the centers of the inner side retaining part 14a and the outer side retaining part 14b are formed to be concentric. Therefore, the stress in the direction perpendicular to the Z axis cannot be generated and remained on the wrist parts 14c. Moreover, the wrist parts 14c of the back side spring component 14B cannot generate restoring force in the direction of −Z axis when the coil 16 is not electrified.

Then, as shown in FIG. 2C, the front side box body 11 is fixed on the +Z side of the outer circumference wall 12a of the back side box body 12 in a manner that the lens support 13 is surrounded. The magnet assembly 15 is mounted on the inner wall of the outer circumference part 11a of the front side box body 11.

Then, after the inner side retaining part 14a of the front side spring component 14A is arranged (not fixed to) on the +Z side surface of the connecting end 13c on the +Z side of the lens support 13, the outer side retaining part 14b of the front side spring component 14A is pressed to the +Z side surface of the top surface part 11c of the front side box body 11 positioned at the position separated from the −Z side at a distance G from the inner side retaining part 14a of the front side spring component 14A. That is to say, a height difference value between inner and outer side retaining parts 14a, 14b of the front side spring component 14A in the direction of Z axis is G.

Right now, only the inner side retaining part 14a of the front side spring component 14A is arranged (not fixed to) on the connecting end 13c on the +Z side of the lens support 13, and is not fixed to the connecting end 13c, and thus when the outer side retaining part 14b is pressed to the top surface part 11c of the front side box body 11, even if the outer side retaining part 14b is offset in the direction (direction of X axis or direction of Y axis) forming the right angle with the Z axis, the wrist parts 14c and the inner side retaining part 14a cannot be offset along with the outer side retaining part 14b. Therefore, the stress in the direction forming the right angle with the Z axis does not remain on the wrist parts 14c, and the state that the inner side retaining part 14a and the outer side retaining part 14b are mutually decentering cannot be formed.

Then, the inner side retaining part 14a of the front side spring component 14A is fixed on the +Z side surface of the connecting end 13c on the +Z side of the lens support 13, and the outer side retaining part 14b of the front side spring component 14A is fixed on the +Z side surface of the top surface part 11c of the front side box body 11. That is to say, the outer side retaining part 14b of the front side spring component 14A is connected onto the front side box body 11 in the state that the outer side retaining part 14b of the front side spring component 14A is positioned closer to the back of the direction of the optical axis (Z axis) than the inner side retaining part 14a of the front side spring component 14A connected to the lens support 13.

Thus, residual stress in the direction (direction of X axis or direction of Y axis) forming the right angle with the Z axis cannot be generated on the wrist parts 14c of the front side spring component 14A, and the wrist parts 14c are connected with the lens support 13 and the front side box body 11 in a state of being bent in the Z direction.

As a result, residual stress in the direction forming the right angle with the Z axis cannot be generated on the wrist parts 14c of the back side spring component 14B and the front side spring component 14A, and the spring force in the direction of −Z axis can be applied to the lens support 13.

When the coil 16 is not electrified, the back end part 13d of the lens support 13 abuts against the base part 12b of the back side box body 12 in a state that the optical axis extends in the direction of the Z axis. Relatively, when the coil 16 is electrified, the coil 16 generates a +Z axis direction driving force greater than the −Z axis direction spring force generated by the front side spring component 14A, so that the lens support leaves away from the base part 12b of the back side box body 12 and floats up in the +Z direction.

Right now, residual stress in the direction forming the right angle with the Z axis does not exist on the wrist parts 14c of the front side spring component 14A and the back side spring component 14B, and thus the inner side retaining part 14a and the outer side retaining part 14b of the front side spring component 14A cannot be eccentric to each other, and the inner side retaining part 14a and the outer side retaining part 14b of the back side spring component 14B cannot be eccentric to each other. Therefore, even if the lens support 13 floats up, the center of the inner side retaining part 14a of the front side spring component 14A cannot move in the direction (direction of X axis or direction of Y axis) perpendicular to the Z axis, the center of the inner side retaining part 14a of the back side spring component 14B cannot move in the direction forming the right angle with the Z axis, and thus the lens support 13 cannot rotate around the axis forming the right angle with the Z axis to be tilted.

Moreover, in the first embodiment, for the front side spring component 14A, after the outer side retaining part 14b is pressed in the Z direction and the inner side retaining part 14a is fixed on the connecting end 13c on the +Z side of the lens support 13, the outer side retaining part 14b is fixed on the top surface part 11c of the front side box body 11. But if the inner side retaining part 14a, the outer side retaining part 14b, and the wrist parts 14c of the back side spring component 14B are mounted on the same plane, the outer side retaining part 14b can be pressed in the Z direction and be fixed on the top surface part 11c of the front side box body 11 after the inner side retaining part 14a of the front side spring component 14A is fixed on the connecting end 13c on the +Z side of the lens support 13, and thus the tilt when the lens support 13 floats up can also be reduced under the offset condition.

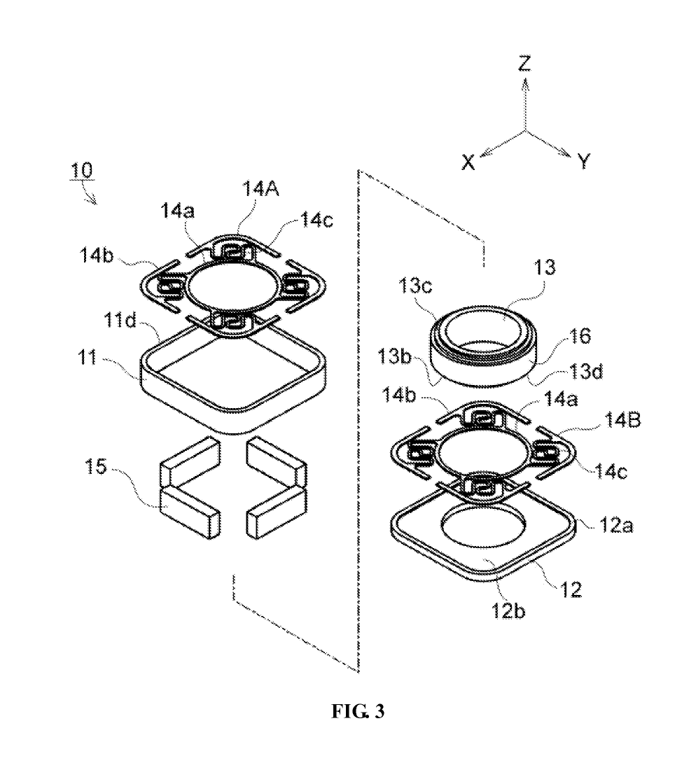

FIG. 3 is an exploded view illustrating a variation example in the first embodiment. The spring components 14 of the lens driving device 10 in the variation example are such designed that the wrist parts 14c bent and extend in the direction of X axis or the direction of Y axis.

The lens driving device 10 is provided with a square frame-shaped front side box body 11, a plate-like back side box body 12 connected with the front side box body 11, a lens support 13 assembled on the inner circumference side of the front side box body 11 and used for retaining a lens, and two spring components 14 composed of a front side spring component 14A and a back side spring component 14B which are mounted on the lens support 13. The back side box body 12 is substantially square and has four corners.

The magnet assembly 15 is formed to be quadrangular, and has four permanent magnets disposed on the inner wall of the front side box body 11. The cylindrical coil 16 is disposed within the inner side of the magnet assembly 15 in a manner of being partitioned at an interval along the radial direction, and are fixed on the outer circumference side surface of the lens support 13. Moreover, the coil 16 and the magnet assembly 15 together form an electromagnetic driving mechanism for driving the lens support 13 in the direction of the optical axis. The lens support 13 can move along the Z direction in the space defined by the inner circumference side of the magnet assembly 15.

The back side box body 12 is arranged on the back side of the optical axis of the lens support 13. A circular opening is formed in the central part of the back side box body 12. The back side box body 12 includes an outer circumference wall 12a arranged along the front side box body 11 and a base part 12b positioned on the back side (−Z side) of the lens support 13. The front side box body 11 is fixed at the front end part of the outer circumference wall 12a of the back side box body 12. Moreover, the outer side retaining part 14b of the back side spring component 14B is fixed on the outer circumference wall 12a.

The lens support 13 is formed to be in the shape of a cylinder capable of housing the not shown lens at the interior. The lens support 13 is mounted on the inner circumference side of the front side box body 11, and can move along the direction of the optical axis (Z axis).

Each spring component 14 is integrally formed to be an annular plate spring, and is used for supporting the lens support 13 to move in the direction of the optical axis of the lens in a suspension manner. Each spring component 14 is provided with a circular ring-shaped inner side retaining part 14a mounted on the side of the lens support 13, a square frame-shaped outer side retaining part 14b, and four wrist parts 14c. The square frame-shaped outer side retaining part 14b includes four L-shaped parts which are arrayed to form a square frame-shaped shape and are separated from one another in each side of the central part of the square frame-shaped shape. The square frame-shaped outer side retaining part 14b is mounted on the side of the back side box body 12. The wrist parts 14c are disposed between the inner side retaining part 14a and the outer side retaining part 14b and each alternately extends along the circumference direction and the diameter direction. Moreover, the four L-shaped edges of the outer side retaining part 14b of the back side spring component 14B can also be connected one another and are closed in a square frame shape.

The inner side retaining part 14a of the front side spring component 14A is fixed on the +Z side surface of the connecting end 13c on the +Z side of the lens support 13, and the outer side retaining part 14b of the front side spring component 14A is fixed on the front end part 11d of the front side box body 11. Moreover, the inner side retaining part 14a of the back side spring component 14B is fixed on the −Z side surface of the connecting end 13b on the −Z side of the lens support 13, and the outer side retaining part 14b of the back side spring component 14B is fixed on the +Z side surface of the outer circumference wall 12a of the back side box body 12.

The assembling steps of the lens driving device in the variation example are the same as the condition as shown in FIG. 2. The inner side retaining part 14a of the back side spring component 14B is fixed on the −Z side connecting end 13b of the lens support 13 provided with the coil 16. Then, after the center of the lens support 13 and the center of the back side box body 12 are aligned at the same position, the lens support 13 connected to the inner side retaining part 14a of the back side spring component 14B abuts against the front side of the base body 12b. Then, the outer side retaining part 14b of the back side spring component 14B is pressed and fixed on the +Z side surface of the outer circumference wall 12a in a manner that the outer side retaining part 14b and the inner side retaining part 14a of the back side spring component 14B are formed in the same height in the Z direction.

In such state, the inner side retaining part 14a, the outer side retaining part 14b, and the wrist parts 14c of the back side spring component 14B are formed on the same plane, and the centers of the inner side retaining part 14a and the outer side retaining part 14b are formed to be concentric. Therefore, the stress in the direction of forming the right angle with the Z axis cannot be generated on the wrist parts 14c, and the stress in the direction of forming the right angle with the Z axis cannot remain. Moreover, the wrist parts 14c of the back side spring component 14B cannot generate restoring force in the direction of −Z axis.

The front side box body 11 provided with the magnet assembly 15 on the inner wall is fixed on the +Z side of the outer circumference wall 12a of the back side box body 12 in a manner that the lens support 13 is surrounded. The inner side retaining part 14a of the front side spring component 14A is arranged (not fixed to) on the +Z side surface of the connecting end 13c on the +Z side of the lens support 13. Moreover, the outer side retaining part 14b of the front side spring component 14A is pressed to the −Z axis, and is pressed on the front end part 11d of the front side box body 11 in an offset state.

Right now, the inner side retaining part 14a of the front side spring component 14A is not fixed on the connecting end 13c on the +Z side of the lens support 13, and thus when the outer side retaining part 14b is pressed to the top surface part 11c of the front side box body 11, the outer side retaining part 14b is offset in the direction (direction of X axis or direction of Y axis) forming the right angle with the Z axis, and the wrist parts 14c and the inner side retaining part 14a can be offset together with the outer side retaining part 14b. Therefore, the stress in the direction forming the right angle with the Z axis does not remain on the wrist parts 14c, and the state that the inner side retaining part 14a and the outer side retaining part 14b are mutually decentering cannot be formed.

Then, the inner side retaining part 14a of the front side spring component 14A is fixed on the +Z side surface of the connecting end 13c on the +Z side of the lens support 13, and the outer side retaining part 14b of the front side spring component 14A is fixed on the front end part 11d of the front side box body 11. That is to say, the outer side retaining part 14b of the front side spring component 14A is connected onto the front side box body 11 in the state that the outer side retaining part 14b of the front side spring component 14A is positioned closer to the back of the direction of the optical axis (Z axis) than the inner side retaining part 14a of the front side spring component 14A connected to the lens support 13.

Thus, residual stress in the direction (direction of X axis or direction of Y axis) forming the right angle with the Z axis cannot be generated on the wrist parts 14c, and the front side spring component 14A is respectively connected with the lens support 13 and the front side box body 11 in a state of being bent in the Z direction.

As a result, residual stress in the direction forming the right angle with the Z axis cannot be generated on the wrist parts 14c of the back side spring component 14B and the front side spring component 14A, and the acting force in the direction of −Z axis can be applied to the lens support 13.

Moreover, when the coil 16 is not electrified, the back end part 13d of the lens support 13 abuts against the base part 12b of the back side box body 12 in a state that the optical axis of the lens coincides to the direction of the Z axis. Relatively, when the coil 16 is electrified, the coil 16 generates +Z axis direction driving force greater than −Z axis direction spring force generated by the front side spring component 14A, so that the lens support leaves away from the base part 12b of the back side box body 12 and floats up in the +Z direction.

Right now, residual stress in the direction forming the right angle with the Z axis does not exist on the wrist parts 14c of the front side spring component 14A and the back side spring component 14B, and thus the inner side retaining part 14a and the outer side retaining part 14b of the front side spring component 14A cannot be eccentric to each other, and the inner side retaining part 14a and the outer side retaining part 14b of the back side spring component 14B cannot be eccentric to each other. In this way, even if the lens support 13 floats up, the center of the inner side retaining part 14a of the front side spring component 14A cannot move in the direction (direction of X axis or direction of Y axis) forming the right angle with the Z axis, the center of the inner side retaining part 14a of the back side spring component 14B cannot move in the direction forming the right angle with the Z axis, and thus the lens support 13 cannot rotate around the axis forming the right angle with the Z axis and can not be tilted.

In this way, even if the lens driving device with the spring components 14 provided with wrist parts 14c alternately extending along the circumference direction and the diameter direction in a zigzag manner is used, the lens support 13 can be prevented from rotating around the axis forming the right angle with the Z axis when floating up.

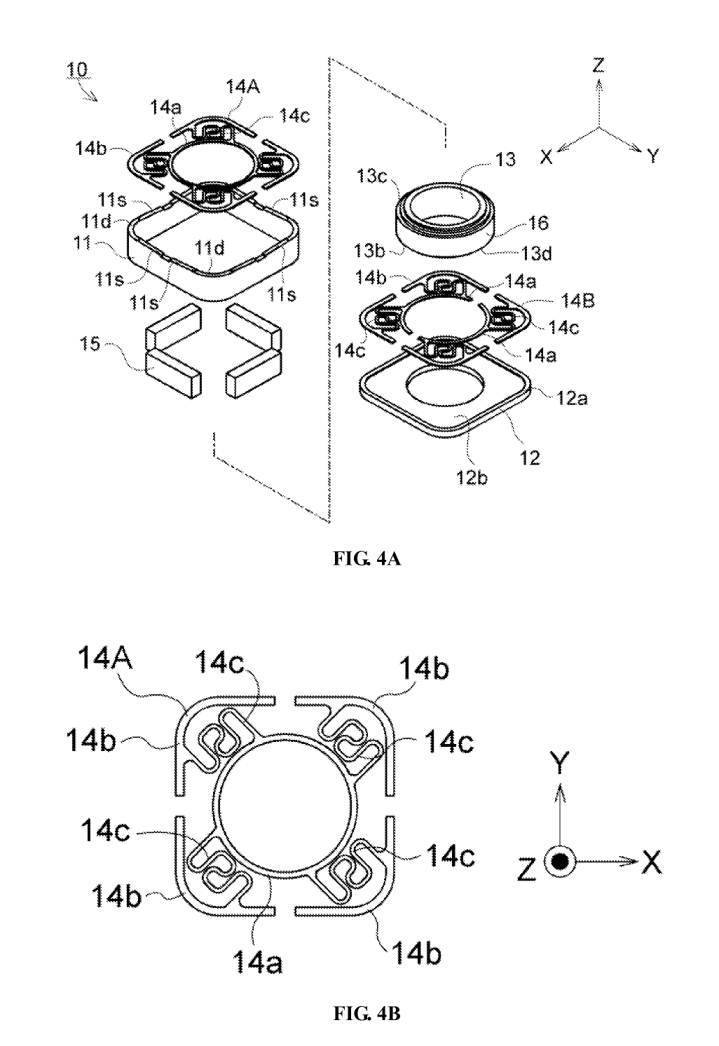

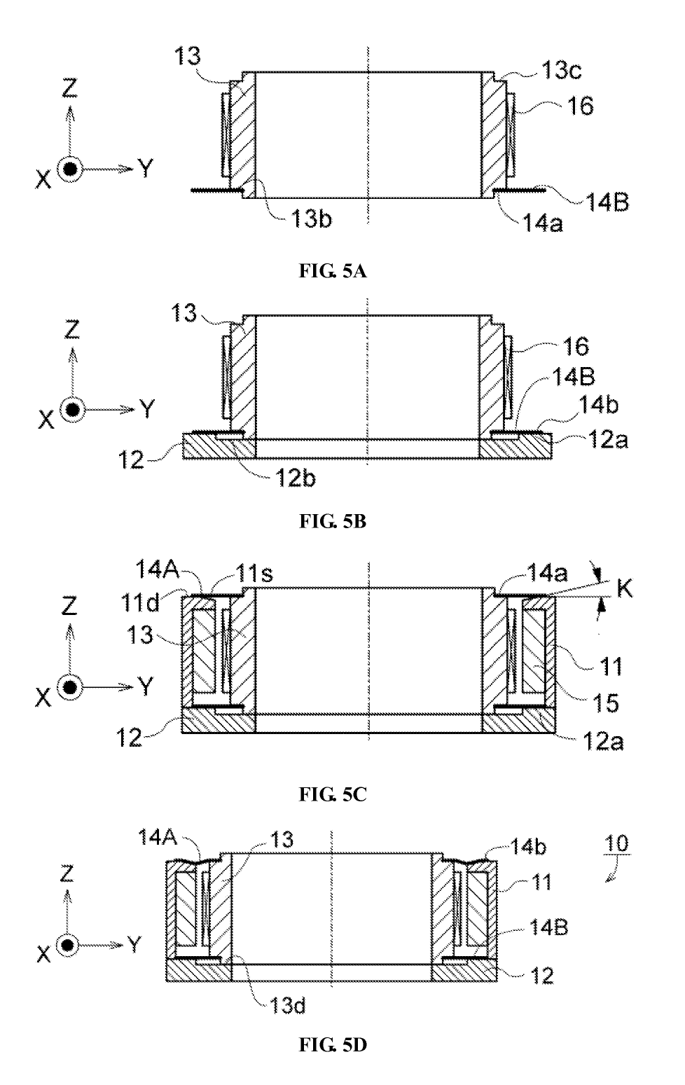

FIG. 4A is an exploded view illustrating the structure of the lens driving device 10 in a second embodiment, and FIG. 4B is a top view illustrating the spring component 14 in the lens driving device 10. Moreover, FIG. 5A to FIG. 5D are section views illustrating the assembling working procedure of the lens driving device 10 in the second embodiment of the present invention.

The lens driving device 10 is provided with a square frame-shaped front side box body 11, a plate-like back side box body 12 connected with the front side box body 11 and having four corners, a lens support 13 assembled on the inner circumference side of the front side box body 11 and used for retaining the lens, and two spring components 14 composed of the front side spring component 14A and the back side spring component 14B which are mounted on the lens support 13. In the description of the embodiment, the direction of the optical axis of the not shown lens is taken as the direction of Z (Z axis), and the side of the object to be shot is taken as the front side (+Z side) of the direction of the optical axis (Z axis). The front side spring component 14A is disposed on the front side (+Z side) of the optical axis of the lens support 13, and the back side spring component 14B is disposed on the back side (−Z side) of the optical axis of the lens support 13.

The front side box body 11 is arranged on the outer circumference side of the lens support 13. Front frame edges on the +Z side of the front side box body 11 includes four front end parts 11d which all form the right angle with the Z axis and are formed on the corners, and eight inclination parts 11s extend from the front end parts 11d towards the centers of the front frame edges in the +Z side. Each inclination part 11s is inclined in the Z direction along the circumference direction. The magnet assembly 15 is formed to be quadrangular, and includes four permanent magnets positioned in a square and disposed on the inner walls of the front side box body 11. The cylindrical coil 16 are disposed opposite to the inner side of the magnet assembly 15 in a manner of being partitioned at intervals along the radial direction relative to the magnet assembly 15, and are fixed on the outer circumference side surface of the lens support 13. Moreover, the coil 16 and the magnet assembly 15 together form the electromagnetic driving mechanism for driving the lens support 13 in the direction of the optical axis. The lens support 13 can move along the Z direction in the space within the inner circumference side of the magnet assembly 15.

The back side box body 12 is arranged on the back side of the optical axis of the lens support 13. A circular opening is formed in the central part of the back side box body 12, and the back side box body 12 includes an outer circumference wall 12a arranged along the front side box body 11 and a base part 12b positioned on the back side (−Z side) of the lens support 13. The front side box body 11 is fixed on the front end part of the outer circumference wall 12a of the back side box body 12. Moreover, the outer side retaining part 14b of the back side spring component 14B is fixed on the outer circumference wall 12a.

The lens support 13 is formed to be in the shape of a cylinder capable of housing the not shown lens at the interior. The lens support 13 is mounted on the inner circumference side of the front side box body 11, and can move along the direction of the optical axis (Z axis).

Each spring component 14 is integrally formed to be annular plate spring, and is used for supporting the lens support 13 to move in the direction of the optical axis of the lens in a suspension manner. The front side spring component 14A is provided with a circular ring-shaped inner side retaining part 14a mounted on the side of the lens support 13, a square frame-shaped outer side retaining part 14b and a plurality of wrist parts 14c. The square frame-shaped outer side retaining part 14b includes four L-shaped parts which are separated from one another at the center of each edge of the outer side retaining part 14b. The outer side retaining part 14b is mounted on the side of the back side box body 12. The wrist parts 14c are disposed between the inner side retaining parts 14a and the outer side retaining parts 14 and alternately extend along the circumference direction and the diameter direction.

The back side spring component 14B is provided with a circular ring-shaped inner side retaining part 14a having two divided circular arcs mounted on the side of the lens support 13, a square frame-shaped outer side retaining part 14b and a plurality of wrist parts 14c. The square frame-shaped outer side retaining part 14b includes four L-shaped parts separated from one another in the center of each edge of the outer side retaining part 14b and mounted on the side of the back side box body 12. The wrist parts 14c are disposed between the inner side retaining part 14a and the outer side retaining part 14b and each alternately extends along the circumference direction and the diameter direction. Moreover, the inner side retaining part 14a of the back side spring component 14B can be formed to be in a circular ring shape but not separated circular arcs. Moreover, the outer side retaining part 14b of the back side spring component 14B can also be formed in the shape that all sides are not separated from one another and are closed in a square frame shape.

The inner side retaining part 14a of the front side spring component 14A is fixed on the +Z side surface of the connecting end 13c on the +Z side of the lens support 13, and the outer side retaining part 14b of the front side spring component 14A is fixed on the inclination parts 11s of the front side box body 11. The inner side retaining part 14a of the back side spring component 14B is fixed on the −Z side surface of the connecting end 13b on the −Z side of the lens support 13, and the outer side retaining part 14b of the back side spring component 14B is fixed on the +Z side surface of the outer circumference wall 12a of the back side box body 12.

Below, referring to FIG. 5, the assembling steps of the lens driving device 10 in the embodiment are described.

As shown in FIG. 5A, the inner side retaining part 14a of the back side spring component 14B is fixed on the −Z side connecting end 13b of the lens support 13 mounted the coil 16. Then, as shown in FIG. 5B, after the center of the lens support 13 and the center of the back side box body 12 are aligned at the same position, the lens support 13 connected to the inner side retaining part 14a of the back side spring component 14B abuts against the front side of the base body 12b. Moreover, in a manner that the heights of the outer side retaining part 14b and the inner side retaining part 14a in the Z direction are the same, the outer side retaining part 14b is pressed and fixed to the +Z side surface of the outer circumference wall 12a of the back side box body 12.

In such state, the inner side retaining part 14a, the outer side retaining part 14b and the wrist parts 14c of the back side spring component 14B are formed on the same plane, and the centers of the inner side retaining part 14a and the outer side retaining part 14b are formed to be concentric. Therefore, the stress in the direction of forming the right angle with the Z axis cannot be generated on the wrist parts 14c, and the stress in the direction of forming the right angle with the Z axis cannot remain. Moreover, the wrist parts 14c of the back side spring component 14B cannot generate restoring force in the direction of −Z axis.

Then, as shown in FIG. 5C, the front side box body 11 is fixed on the +Z side of the outer circumference wall 12a of the back side box body 12 in a manner that the lens support 13 is surrounded. The magnet assembly 15 is mounted on the inner wall of the outer circumference part 11a of the front side box body 11. Then, the inner side retaining part 14a of the front side spring component 14A is arranged (not fixed to) on the +Z side surface of the connecting end 13c on the +Z side of the lens support 13.

Right now, the height of the front end part 11d of the front side box body 11 in the Z direction is the same as that of the connecting end on the +Z side of the lens support 13, and the outer side retaining part 14b of the front side spring component 14A cannot droop in the Z direction and can be disposed in a flat state. Moreover, as shown in FIG. 5C and FIG. 5D, before the inner side retaining part 14a is fixed on the connecting end 13c, the outer side retaining part 14b is pressed on the inclination parts 11s of the front side box body 11 with an inclination angle K in the Z direction. That is to say, the outer side retaining part 14b of the front side spring component 14A is connected with the inclination parts 11s of the front side box body 11 in a state that the outer side retaining part 14b of the front side spring component 14A is not parallel to the plane forming the right angle with the optical axis.

Right now, the inner side retaining part 14a of the front side spring component 14A is not fixed on the connecting end 13c on the +Z side of the lens support 13, and thus when the outer side retaining part 14b is pressed to the front end part 11d of the front side box body 11, the outer side retaining part 14b is offset in the direction (direction of X axis or direction of Y axis) forming the right angle with the Z axis, and the wrist parts 14c and the inner side retaining part 14a can be offset together with the outer side retaining part 14b. Therefore, the stress in the direction forming the right angle with the Z axis does not remain on the wrist parts 14c, and the state that the inner side retaining part 14a and the outer side retaining part 14b are mutually decentering cannot be formed. Moreover, the front side spring component 14A before being fixed on the front side box body 11 can be disposed in the flat state, and the outer side retaining part 14b cannot be eccentric due to drooping.

Then, the inner side retaining part 14a of the front side spring component 14A is fixed on the +Z side surface of the connecting end 13c on the +Z side of the lens support 13, and the outer side retaining part 14b of the front side spring component 14A is fixed on the inclination parts 11s of the front side box body 11. That is to say, the outer side retaining part 14b of the front side spring component 14A is connected onto the front side box body 11 in the state that the outer side retaining part 14b of the front side spring component 14A is slanted closer to the back of the optical axis (Z axis) than the inner side retaining part 14a of the front side spring component 14A connected to the lens support 13.

Thus, residual stress in the direction (direction of X axis or direction of Y axis) forming the right angle with the Z axis cannot be generated on the wrist parts 14c, and the front side spring component 14A is respectively connected with the lens support 13 and the front side box body 11 in a state of being bent in the Z direction. As a result, residual stress in the direction forming the right angle with the Z axis cannot be generated on the wrist parts 14c of the back side spring component 14B and the front side spring component 14A, and thus the acting force in the direction of −Z axis can be applied to the lens support 13.

Moreover, when the coil 16 is not electrified, the back end part 13d of the lens support 13 abuts against the base part 12b of the back side box body 12 in a state that the optical axis of the lens coincides to the direction of the Z axis. Relatively, when the coil 16 is electrified, the coil 16 generates +Z axis direction driving force greater than −Z axis direction spring force generated by the front side spring component 14A, so that the lens support leaves away from the base part 12b of the back side box body 12 and floats up in the +Z direction.

Right now, residual stress in the direction forming the right angle with the Z axis does not exist on the wrist parts 14c of the front side spring component 14A and the back side spring component 14B, and thus the inner side retaining part 14a and the outer side retaining part 14b of the front side spring component 14A cannot be eccentric to each other, and the inner side retaining part 14a and the outer side retaining part 14b of the back side spring component 14B cannot be eccentric to each other. In this way, even if the lens support 13 floats up, the center of the inner side retaining part 14a of the front side spring component 14A cannot move in the direction (direction of X axis or direction of Y axis) forming the right angle with the Z axis, the center of the inner side retaining part 14a of the back side spring component 14B cannot move in the direction forming the right angle with the Z axis, and thus the lens support 13 cannot rotate around the axis forming the right angle with the Z axis to be inclined.

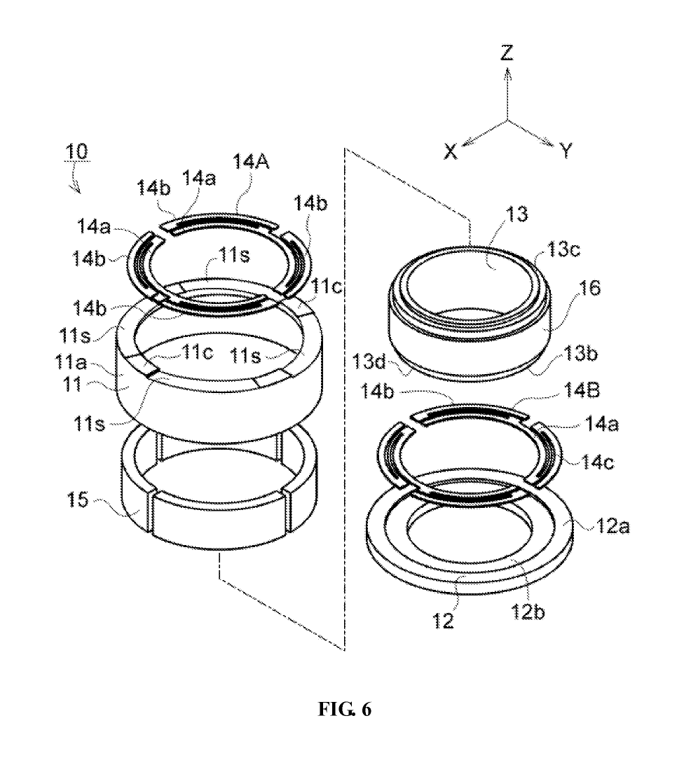

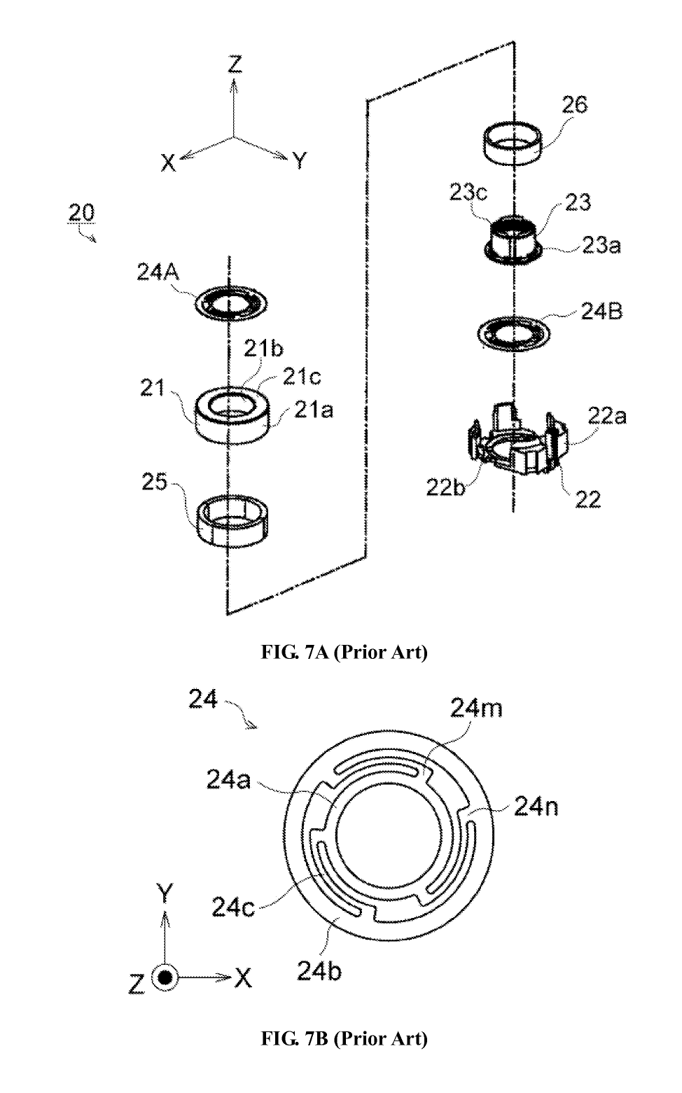

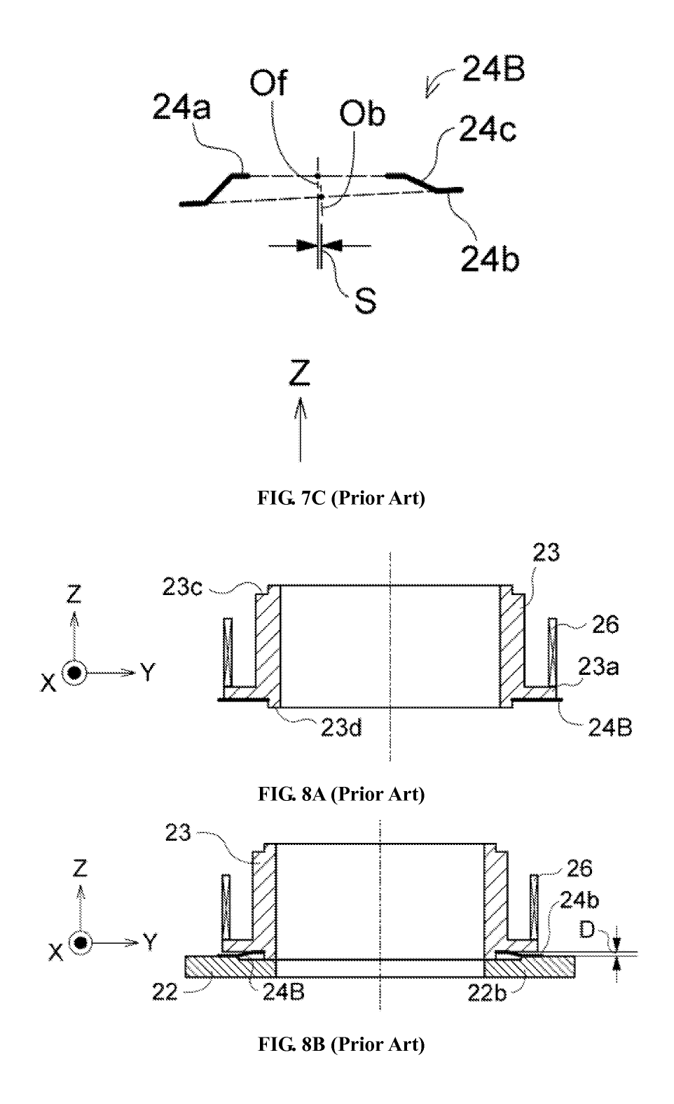

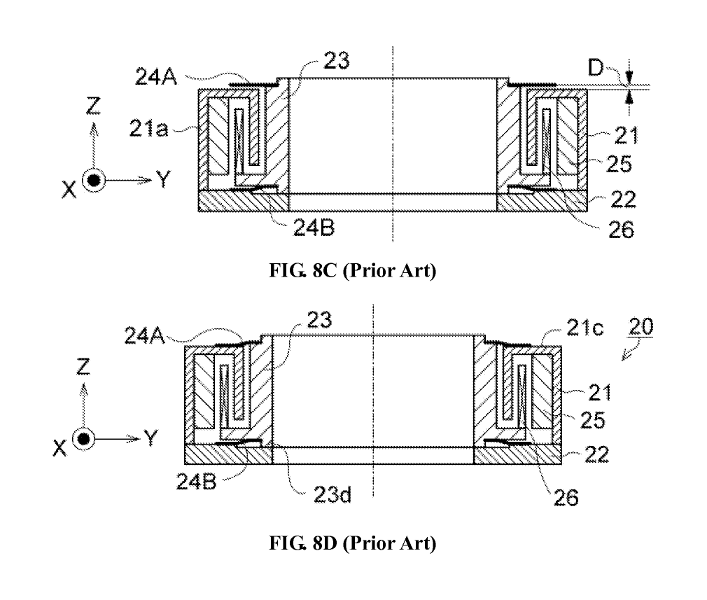

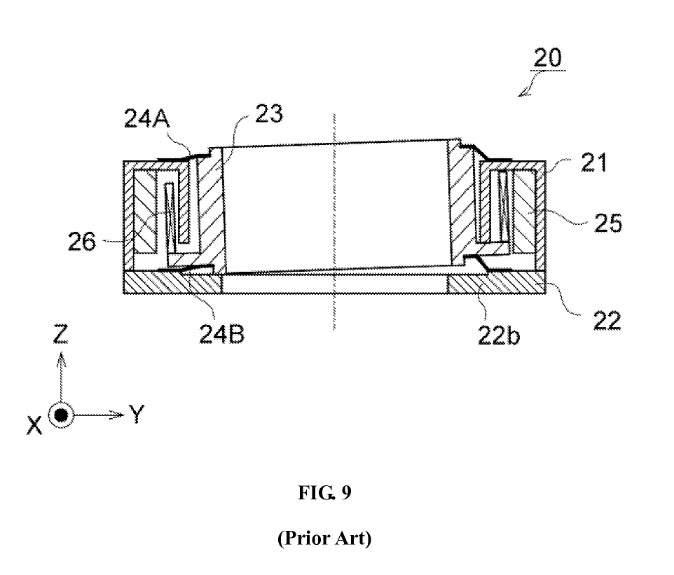

FIG. 6 is an exploded view illustrating a variation example in the second embodiment. The spring components 14 of the lens driving device 10 in the variation example are formed to be the shape that the wrist parts 14c extends in the circumference direction.

The lens driving device 10 is provided with a cylindrical front side box body 11, a back side box body 12 connected with the front side box body 11, a lens support 13 assembled on the inner circumference side of the front side box body 11 and used for retaining a lens, and spring components 14 composed of a front side spring component 14A and a back side spring component 14B which are mounted on the lens support 13.

The front side box body 11 is formed by a soft magnetic body and is arranged on the outer circumference side of the lens support 13 so as to serve as a magnetic yoke to play functions and effects. The front side box body 11 is provided with an approximately L-shaped cross section, and is composed of an outer circumference part 11a and a top surface part 11c bent from the +Z side of the outer circumference part 11a to the direction of the inner diameter. Several inclination parts 11s inclined in the Z direction along the circumference direction are arranged on the top surface part 11c.

The magnet assembly 15 is formed to be arc columnar, and includes four magnets positioned in a circle and disposed on the inner wall of the outer circumference part 11a of the front side box body 11. The cylindrical coil 16 is disposed opposite to the inner side of the magnet assembly 15 in a manner of being partitioned at intervals along the radial direction, and are fixed on the outer circumference side surface of the lens support 13. Moreover, the coil 16 and the magnet assembly 15 together form the electromagnetic driving mechanism for driving the lens support 13 in the direction of the optical axis. The lens support 13 can move along the Z direction in the space of the inner circumference side of the magnet assembly 15.

The back side box body 12 is arranged on the back side of the optical axis of the lens support 13. A circular opening is formed in the central part of the back side box body 12, and the back side box body 12 includes an outer circumference wall 12a arranged along the outer circumference part 11a of the front side box body 11 and a base part 12b positioned on the back side (−Z side) of the lens support 13. The front side box body 11 is fixed on the front end part of the outer circumference wall 12a of the back side box body 12. Moreover, the outer side retaining part 14b of the back side spring component 14B is fixed on the outer circumference wall 12a.

The lens support 13 is formed to be in the shape of a cylinder capable of housing the not shown lens at the interior. The lens support 13 is mounted on the inner circumference side of the front side box body 11, and can move along the direction of the optical axis (Z axis).

Each spring component 14 is integrally formed to be an annular plate spring, and is used for supporting the lens support 13 to move in the direction of the optical axis of the lens in a suspension manner. Each spring component 14 includes a circular ring-shaped inner side retaining part 14a composed of two separated circular arc-shaped parts mounted on the side of the lens support 13, a circular outer side retaining part 14b composed of four separated circular arc-shaped parts mounted on the side of the back side box body 12, and four wrist parts 14c connected between the inner side retaining part 14a and the outer side retaining part 14b and extending in the circumference direction. Moreover, the four separated circular arc-shaped parts of the outer side retaining part 14b of the front side spring component 14A are respectively and independently arranged on the ends of the four wrist parts 14c. Moreover, the outer side retaining part 14b of the front side spring component 14A needs to be divided into four parts, but the inner side retaining part 14a can also be formed in a continuous ring shape. Moreover, the inner side retaining part 14a of the back side spring component 14B can also be formed in the continuous ring shape, and the outer side retaining part 14b of the back side spring component 14B can also be formed in the continuous ring shape.

The inner side retaining part 14a of the front side spring component 14A is fixed on the +Z side surface of the connecting end 13c on the +Z side of the lens support 13, and the outer side retaining part 14b of the front side spring component 14A is fixed on the inclination parts 11s of the front side box body 11. The inner side retaining part 14a of the back side spring component 14B is fixed on the −Z side surface of the connecting end 13b on the −Z side of the lens support 13, and the outer side retaining part 14b of the back side spring component 14B is fixed on the +Z side surface of the outer circumference wall 12a of the back side box body 12.

As assembling steps of the lens driving device in the variation example, the inner side retaining part 14a of the back side spring component 14B is fixed on the −Z side connecting end 13b of the lens support 13 provided with the coil 16. Moreover, after the center of the lens support 13 and the center of the back side box body 12 are aligned at the same position, the lens support 13 connected to the inner side retaining part 14a of the back side spring component 14B abuts against the front side of the base body 12b. The outer side retaining part 14b of the back side spring component 14B is pressed and fixed on the +Z side surface of the outer circumference wall 12a in a manner that the outer side retaining part 14b and the inner side retaining part 14a of the back side spring component 14B are formed in the same height in the Z direction.

In such state, the inner side retaining part 14a, the outer side retaining part 14b and the wrist parts 14c of the back side spring component 14B are formed on the same plane, and the centers of the inner side retaining part 14a and the outer side retaining part 14b are formed to be concentric. Therefore, the stress in the direction of forming the right angle with the Z axis cannot be generated on the wrist parts 14c, and the stress in the direction of forming the right angle with the Z axis cannot remain. Moreover, the wrist parts 14c of the back side spring component 14B cannot generate restoring force in the direction of −Z axis.

Then, the front side box body 11 provided with the magnet assembly 15 on the inner wall of the outer circumference part 11a is fixed on the +Z side of the outer circumference wall 12a of the back side box body 12 in a manner that the lens support 13 is surrounded. The inner side retaining part 14a of the front side spring component 14A is arranged (not fixed to) on the +Z side surface of the connecting end 13c on the +Z side of the lens support 13.

Right now, the height of the front end part 11c of the front side box body 11 in the Z direction is the same as that of the connecting end on the +Z side of the lens support 13, and the outer side retaining part 14b of the front side spring component 14A cannot droop in the Z direction and can be disposed in a flat state.

Moreover, before the inner side retaining part 14a is fixed on the connecting end 13c, the outer side retaining part 14b is pressed on the inclination parts 11s of the front side box body 11 inclined in the Z direction.

In this way, the inner side retaining part 14a of the front side spring component 14A is not fixed on the connecting end 13c on the +Z side of the lens support 13, and thus when the outer side retaining part 14b is pressed to the inclination parts 11s of the front side box body 11, the outer side retaining part 14b is offset in the direction (direction of X axis or direction of Y axis) forming the right angle with the Z axis, and the wrist parts 14c and the inner side retaining part 14a can be offset together with the outer side retaining part 14b. Therefore, the stress in the direction forming the right angle with the Z axis does not remain on the wrist parts 14c, and the inner side retaining part 14a and the outer side retaining part 14b are not in the state of being eccentric to each other. Moreover, the front side spring component 14A before being fixed on the front side box body 11 can be disposed in the flat state, and the outer side retaining part 14b cannot be eccentric due to drooping.

Then, the inner side retaining part 14a of the front side spring component 14A is fixed on the +Z side surface of the connecting end 13c on the +Z side of the lens support 13, and the outer side retaining part 14b of the front side spring component 14A is fixed on the inclination parts 11s of the front side box body 11. That is to say, the outer side retaining part 14b of the front side spring component 14A is connected onto the front side box body 11 in the state that the outer side retaining part 14b of the front side spring component 14A is slanted closer to the back of the direction of the optical axis (Z axis) than the inner side retaining part 14a of the front side spring component 14A connected to the lens support 13.

Thus, under the condition that residual stress in the direction (direction of X axis or direction of Y axis) forming the right angle with the Z axis cannot be generated on the wrist parts 14c, the front side spring component 14A is connected with the lens support 13 and the front side box body 11 in a state of being bent in the Z direction.

As a result, residual stress in the direction forming the right angle with the Z axis cannot be generated on the wrist parts 14c of the back side spring component 14B and the front side spring component 14A, and the acting force in the direction of −Z axis can be applied to the lens support 13.

When the coil 16 is not electrified, the back end part 13d of the lens support 13 abuts against the base part 12b of the back side box body 12 in a state that the optical axis of the lens coincides to the direction of the Z axis. Relatively, when the coil 16 is electrified, the coil 16 generates +Z axis direction driving force greater than −Z axis direction spring force generated by the front side spring component 14A, and the lens support leaves away from the base part 12b of the back side box body 12 and floats up in the +Z direction.

Right now, residual stress in the direction forming the right angle with the Z axis does not exist on the wrist parts 14c of the front side spring component 14A and the back side spring component 14B, and thus the inner side retaining part 14a and the outer side retaining part 14b of the front side spring component 14A cannot be eccentric to each other, and the inner side retaining part 14a and the outer side retaining part 14b of the back side spring component 14B cannot be eccentric to each other. Therefore, even if the lens support 13 floats up, the center of the inner side retaining part 14a of the front side spring component 14A cannot move in the direction (direction of X axis or direction of Y axis) forming the right angle with the Z axis, the center of the inner side retaining part 14a of the back side spring component 14B cannot move in the direction forming the right angle with the Z axis, and thus the lens support 13 cannot rotate around the axis forming the right angle with the Z axis to be inclined.

In this way, even if the lens driving device with the spring components 14 provided with wrist parts 14c extending along the circumference direction is used, the lens support 13 can be prevented from rotating around the axis forming the right angle with the Z axis when floating up.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A lens driving device, comprising:
a lens support configured for retaining a lens therein, a side of an object to be shot being taken as a front side of an optical axis of the lens;
a box body arranged on an outer side of the lens support;
two plate-like spring components configured for connecting the lens support with the box body and supporting the lens support in a suspension manner to move along the optical axis of the lens; and
an electromagnetic driving mechanism configured for driving the lens support to move along the optical axis;
wherein the two spring components comprise a front side spring component configured for supporting a front side of the lens support in a direction of the optical axis and a back side spring component configured for supporting a back side of the lens support in the direction of the optical axis;
wherein each of the front side spring component and the back side spring component comprises:
a plurality of wrist parts;
an inner side retaining part configured in an inner side of the plurality of wrist parts and connected with the lens support; and
an outer side retaining part configured on an outer side of the plurality of wrist parts and connected with the box body;
wherein one end of each wrist part is connected with the inner side retaining part, and the other end of each wrist part is connected with the outer side retaining part;
wherein the outer side retaining part of the back side spring component, connected with the box body, and the inner side retaining part of the back side spring component connected with the lens support are located in a same plane;
wherein the outer side retaining part of the front side spring component is connected with the box body in a manner that the outer side retaining part of the front side spring component is positioned closer to a back side of the optical axis than the inner side retaining part of the front side spring component connected with the lens support, and the lens support is subjected to an acting force in the back side of the direction of the optical axis.

2. A lens driving device, comprising:
a lens support configured for retaining a lens therein, a side of an object to be shot being taken as a front side of an optical axis of the lens;
a box body arranged on an outer side of the lens support;
two plate-like spring components configured for connecting the lens support with the box body and supporting the lens support in a suspension manner to move along the optical axis of the lens; and
an electromagnetic driving mechanism configured for driving the lens support to move along the optical axis;
wherein the two spring components comprise a front side spring component for supporting a front side of the lens support in a direction of the optical axis and a back side spring component for supporting a back side of the lens support in the direction of the optical axis;
wherein each of the front side spring component and the back side spring component comprises:
a plurality of wrist parts;
an inner side retaining part configured in an inner side of the plurality of wrist parts and connected with the lens support; and
an outer side retaining part configured on an outer side of the plurality of wrist parts and connected with the box body;
wherein one end of each wrist part is connected with the inner side retaining part, and the other end of each wrist part is connected with the outer side retaining part;
wherein the outer side retaining part of the back side spring component are connected with the box body in a manner that the outer side retaining part of the back side spring component and the inner side retaining part of the back side spring component connected to the lens support are located in a same plane;
wherein the outer side retaining part of the front side spring component are divided into a plurality of separated parts each connected with a corresponding one of the plurality of wrist parts, and the outer side retaining part of the front side spring component is connected with the box body in a state that each separated part is not parallel to a plane perpendicular to the optical axis, and thus the lens support is subjected to an acting force towards the back of the optical axis.
